(19) United States
(12) Patent Application Publication
(10) Pub. No.: US 2002/0116700 A1
(43) Pub. Date: Aug. 22, 2002

(54) Method for linking non-object oriented data models to object oriented data models using a technique to achieve zero-size object mapping

(76) Inventor: Clemente Izurieta, Ft. Collins, CO (US)

Correspondence Address: HEWLETT-PACKARD COMPANY, Intellectual Property Administration, P.O. Box 272400, Fort Collins, CO, 80527-2400, US

(21) Appl. No.: 09/782,405

(22) Filed: Feb. 12, 2001

(51) Int. Cl. G06F 17/00

(52) U.S. Cl. 717/102; 707/101

(57) ABSTRACT

A method and apparatus for linking non-object oriented data models to object oriented data models without incurring any additional memory. Non-object oriented data is loaded into memory and represented by a C-structure. The structure definition contains information about the data. In the object oriented model, instead of creating another memory for the data located in the structure, the object oriented model maps onto the non-object oriented structure. As a result, the programmer abstraction and object encapsulation benefits of an object oriented model without adding to the memory size.

### TECHNICAL FIELD

This invention relates to object mapping. In particular, the invention relates to a technique for retrieving non-object oriented data from within an object oriented model using zero-size object mapping.

### BACKGROUND

The complexity of designing a VLSI chip has produced numerous CAD automation tools that help designers with synthesis and abstraction across behavioral, structural and layout domains. Central to all tools lies an information model that describes how information is organized. The information model is an abstraction of a data model, which in turn describes implementation details.

There are multiple CAD infrastructures in use. Legacy infrastructures have been developed over many years and thus there has been significant investment by companies in terms of designs, engines, or programs that use this middleware. Emerging CAD infrastructures use object oriented models. The present invention attempts to map an object oriented model into a legacy type. To access the data in the legacy model, the designers do not want to copy all the data onto the object oriented model because this would be very expensive. Thus there is a need for a method of overlaying the memory that the legacy model contains with the new object oriented model.

As object oriented methodologies become more pervasive, there has been an increase in object oriented based data models for CAD infrastructures. The need to support legacy data models that are structural in nature forces designers to look for alternatives that adopt new technologies and preserve existing investments. Unfortunately, these tasks are at odds with each other, requiring either full adoption, or the improvement of legacy data models.

Currently, there are several techniques that use zero-size objects to achieve a mapping between non-object oriented data models and object oriented based models. Zero-size object mapping is a form of overlying existing memory occupied by another object. Some prior coding techniques to achieve zero-size object mapping are reinterpret casts and placement of objects.

Reinterpret casts is a form of explicit type conversion that can also be used to overlay existing memory. A reinterpret_cast operation converts between types of objects even when objects are totally unrelated. This can cause serious problems if the memory images of the types are different. In addition, this technique of overlay memory is also non-portable. In reinterpret cast, non-portable means this methodology would not work the same way as on a machine on which the code was compiled.

The placement of objects technique is a method that overloads the new operator. This technique specifically forces the new operator to place the new object at a specific memory location rather than using the heap and free store method of the reinterpret cast.

Additional alternatives to these two methodologies include keeping two separate data models that must be kept in sync at all times. However, this incurs a lot of memory usage. In addition, the designer can choose to either keep and improve the legacy system or migrate to a brand new CAD interface. However, this would be both time consuming and expensive since additional memory would be required.

True interoperability between CAD infrastructures is a difficult challenge, and no business can afford to choose a new system that ignores the investments on non-object oriented infrastructures. The present invention is one that can be used as an evolutionary approach to help drive new technologies while continuing to use existing legacy databases.

### SUMMARY

The present invention solves the problem of merging a non-object oriented data model, with a new object oriented data model. Since both models are used, the benefits of an integrated information model will greatly facilitate the development of new tools. Using the present invention to achieve zero-sized objects to merge the two data models allows the designers of two CAD infrastructures a portal via which they can now potentially have bi-directional access between models. In addition, even if designers use disparate APIs to access data, their information is automatically synchronized because they refer to the same memory area.

### DESCRIPTION OF THE DRAWINGS

The detailed description will refer to the following figures in which like numeral refer to like items, and in which:

FIG. 1 is a block diagram of a computer system with a preferred embodiment of the present invention;

FIG. 2 is a diagram illustrating mapping data between two different models; and

FIG. 3 is a flow chart illustrating the steps to creating a zero-size object mapping.

### DETAILED DESCRIPTION

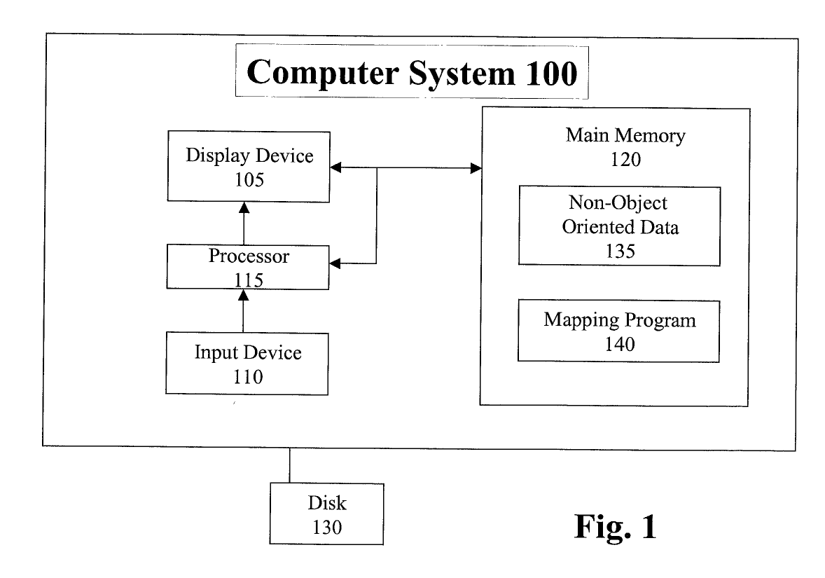

FIG. 1 is a block diagram of a computer system 100. The computer system 100 comprises a display device 105, an input device 110, and a processor 115 connected to a main memory 120. The system 100 components are interconnected through the use of a system bus 125. A mass storage device 130, such as a floppy disk drive, is connected to the computer system 100. The computer system 100 may store data to and read data from the disk 130.

The main memory 120 contains non-objected oriented data 135 and a mapping program 140 in accordance with the preferred embodiment. The non-object oriented data 135 could be stored within, for example, C-structures. The mapping program 140 will map an object to an image in memory 120 occupied by the non-object oriented data 135. By mapping directly into the memory 120 occupied by the non-object oriented data, no new or additional memory allocation is required. This is known as zero-size object mapping. Zero-size object mapping is a form of overlying existing memory occupied by another object.

Before discussing how the mapping occurs between a object oriented model and a non-object oriented model, a few key terms will be defined as used with conventional object oriented programming.

One concept in object oriented programming is class. A class is a template that defines a type of object. A programmer may define a class by having a section of code known as a class definition. An object is an instance of a class. An object may include attributes or data as well as functions or methods. The class definition specifies the attributes and methods. The attributes are represented in an object by the values of instance variables.

Another concept in object oriented programming is inheritance. Inheritance is the ability to derive a new class from one or more existing classes. The new class, known as a subclass, may inherit or incorporate all properties of a base class, including its attributes and its methods.

Another concept in object oriented programming is encapsulation. A class definition may specify that the data of objects of that class is private and cannot be retrieved by another object. Objects must communicate with one another via their object interfaces, and the data may be encapsulated by limiting access to it through the object interface.

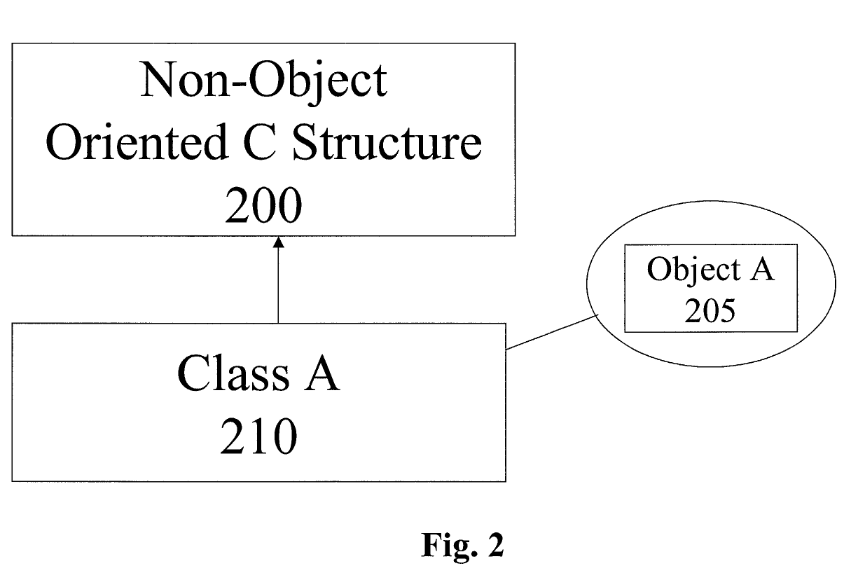

FIG. 2 illustrates how the data is mapped. Initially, a non-object oriented system 200 has some memory representation of a C-structure. The structure definition contains information about the data. In the object oriented system, instead of creating another memory for the data located in the non-object oriented system 200, the object oriented system maps onto the non-object oriented memory.

When a programmer creates an instance of that structure in memory, the programmer has to allocate memory to hold that information. In order to map, the object oriented system inherits the non-object oriented data that came from the C structure. Inheritance allows the programmer to access the non-object oriented structure or any other base structure's data. By inheriting, the system 100 is creating a child class A 210. The child class A 210 represents the definition of the object oriented based object A 205 and derives it from the non-object oriented C structure 200. When an instance of the derived class A 210 is instantiated through static casting, the new object will have full access to the non-object oriented information contained in the C structure 210. Upon static casting, the designer can now use object oriented processes to access the non-object oriented data. As a result, the programmer achieves the abstraction and object encapsulation benefits of an object oriented system without adding to the size of the non-object oriented data. Thus, the new object will have achieved full encapsulation of the non-object oriented data in a natural and easy to maintain mechanism.

Therefore, every time a programmer creates an object, instead of allocating new memory, the programmer maps from the object oriented system onto the non-object oriented data. Now the programmer can use the object oriented system to access the non-object oriented data. Furthermore, this process is transparent to the user who does not know any other system besides the object oriented system.

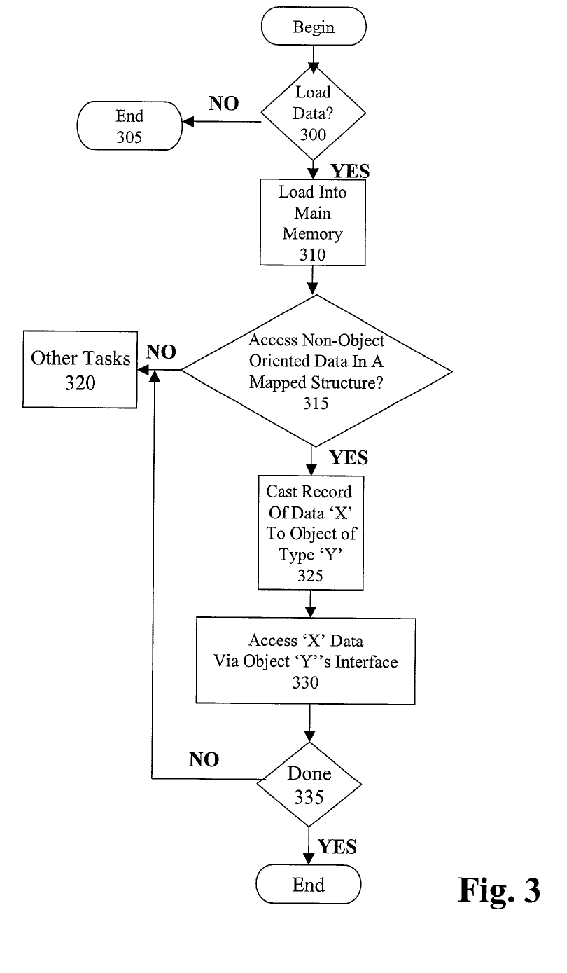

FIG. 3 illustrates the steps to mapping an object oriented object to an image in memory occupied by a non-object oriented data model. Initially the system 100 determines if data should be loaded in memory 120 (step 300). If the data should not be loaded, the system ends the program (step 305), otherwise the data is loaded into the memory 120 (step 310). Next, the programmer has to decide if they want to access the non-objected oriented data in a mapped structure (step 315). If the programmer does not want the data in a mapped structure, they can perform other tasks (step 320). Otherwise, the programmer casts the last record of a particular data element X in the non-object oriented structure to an object Y in the object oriented model (step 325). Next the programmer accesses data element X using object Y's interface (step 330). Now the system has achieved zero-sized mapping using inheritance. If the programmer is done, the process is completed (step 335), otherwise the programmer performs other tasks (step 320).

Entire non-object oriented data models can be mapped to object oriented based data models using the above technique. The object oriented based data models can in turn define many new interfaces to access non-object oriented data without incurring any memory size on these new objects. This technique preserves investment and applies object oriented based methods to not only expand access, but also do it without incurring additional memory.

In the claims:

1. An apparatus comprising:
at least one processor;
a memory coupled to the processor, wherein the memory stores non-object oriented data; and
a mapping software residing in memory, wherein the processor executes the mapping software to map an object onto the non-objected oriented data located in the memory without requiring any substantial memory in addition to a portion of the memory storing the non-object oriented data.

2. The apparatus of claim 1 wherein the data is mapped with zero size memory.

3. The apparatus of claim 1 wherein the non-object oriented data is stored within a legacy data structure.

4. A method for retrieving non-object oriented data from within an object oriented model, the method comprising the steps of:
loading memory with non-object oriented data;
mapping an object oriented model onto a memory space occupied by the nonobject oriented data without requiring substantial additional memory space; and
retrieving a non-object oriented data element from the memory in the object oriented model.

5. The method of claim 4 wherein the step of mapping further comprising:
inheriting the non-object oriented data from memory.

6. The method of claim 5 wherein the step of mapping further comprising:
creating a class from the non-object oriented data.

7. The method of claim 6 wherein the step of mapping further comprising:
instantiating an instance of the class.

8. The method of claim 7 wherein the step of instantiating occurs through static casting.

9. The method of claim 4 wherein the step of mapping further comprising:
accessing the non-object oriented data using a object oriented model.

10. The method of claim 4 wherein the step of retrieving occurs with zero size memory.

11. The method of claim 4 wherein the non-object oriented data are stored within a legacy data structure.

12. A method for retrieving non-object oriented data from within an object oriented model, the method comprising the steps of:
loading memory with non-object oriented data;
mapping an object oriented model onto a memory space occupied by the nonobject oriented data located in the memory without requiring any substantial memory in addition to a portion of the memory storing the non-object oriented data;
retrieving a non-object oriented data element from the memory in the object oriented model.

13. The method of claim 12 wherein the step of mapping further comprising:
inheriting the non-object oriented data from memory.

14. The method of claim 13 wherein the step of mapping further comprising:
creating a class from the non-object oriented data.

15. The method of claim 14 wherein the step of mapping further comprising:
instantiating an instance of the class.

16. The method of claim 15 wherein the step of instantiating occurs through static casting.

17. The method of claim 12 wherein the step of mapping further comprising:
accessing the non-object oriented data using a object oriented model.

18. The method of claim 12 wherein the step of retrieving occurs with zero size memory.

19. The method of claim 12 wherein the non-object oriented data are stored within a legacy data structure.
